(19) United States
(12) Patent Application Publication
(10) Pub. No.: US 2013/0234443 A1
(43) Pub. Date: Sep. 12, 2013

(54) WIND POWER TURBINE AUXILIARY UNIT

(71) Applicant: Matteo Casazza, Val Di Vizze (IT)

(72) Inventor: Matteo Casazza, Val Di Vizze (IT)

(73) Assignee: WILIC S.AR.L., Luxembourg (LU)

(21) Appl. No.: 13/605,710

(22) Filed: Sep. 6, 2012

(30) Foreign Application Priority Data
Sep. 7, 2011 (IT) MI2011A 0001606

(51) Int. Cl. H02K 7/18; E04G 21/14; E04H 12/00; E04H 12/34

(52) U.S. Cl. CPC H02K 7/1823; E04H 12/34; E04G 21/14; E04H 12/00
USPC 290/55; 52/123.1; 52/745.17

(57) ABSTRACT

An auxiliary unit for a wind power turbine having a nacelle and a rotary electric machine; the auxiliary unit having a frame configured to connect the nacelle of the wind power turbine and defining an auxiliary chamber for housing at least one device for conditioning electric energy produced by the rotary electric machine; and a bridge crane for handling the device inside and outside the auxiliary chamber.

### PRIORITY CLAIM

This application claims the benefit of and priority to Italian Patent Application No. MI2011A 0001606, filed on Sep. 7, 2011, the entire contents of which is incorporated by reference herein.

### BACKGROUND

Certain known wind power turbines comprise a vertical structure; a nacelle mounted for rotation on top of the vertical structure; a blade assembly for converting the kinetic energy of the wind to rotation; and a rotary electric machine for converting rotation to electric energy which is fed into the electric power grid. In addition to the rotary electric machine, certain wind power turbines also comprise a number or quantity of devices (e.g., electric devices, electronic devices and mechanical devices) for feeding the electric energy produced into the grid with the correct frequency and phase.

The space available inside the nacelle is sometimes limited: (i) because of the maximum permitted width of the nacelle (the size of which affects the aerodynamic profile of the turbine); (ii) because of weight problems; and (iii) because of problems concerning the construction of the nacelle and the structure of the turbine itself. Moreover, to increase the electric power of the turbine once it is installed, even more space is required, over and above that calculated at the design stage.

In other words, the space inside the nacelle is not always sufficient to accommodate all the equipment necessary to operate the turbine.

One known solution of installing the equipment along the inside of the vertical structure has the drawback of reducing the space inside the structure for access by workers, maintenance equipment and spare parts.

Another known solution of installing the equipment outside the vertical structure, close to the foundation of the turbine, has the drawback of requiring long, large-cross-section, low-voltage cables to connect the rotary electric machine.

### SUMMARY

The present disclosure relates to a wind power turbine auxiliary unit.

More specifically, the present disclosure provides a wind power turbine auxiliary unit configured to eliminate certain of the drawbacks of certain known wind power turbine auxiliary units.

According to one embodiment of the present disclosure, there is provided an auxiliary unit for a wind power turbine including a nacelle and a rotary electric machine; the auxiliary unit including a frame configured to connect to the nacelle of the wind power turbine and defining an auxiliary chamber for housing at least one device for conditioning electric energy produced by the rotary electric machine; and a bridge crane configured to handle the device inside and outside the auxiliary chamber.

The auxiliary unit according to one embodiment of the present disclosure provides space close to the nacelle and the rotary electric machine, by providing an auxiliary chamber in which to house the turbine operating device. Once the auxiliary unit is fitted to the nacelle, the device is therefore located adjacent to the rotary electric machine, thus solving certain of the problems posed by limited manoeuvring space inside the turbine, and with no need for long electric cables.

Moreover, in certain embodiments of the present disclosure, the device can be handled using the bridge crane, for faster, easier maintenance and installation.

The auxiliary unit according to one embodiment of the present disclosure may also be used to advantage for retrofit enhancing existing wind power turbines.

In one embodiment, the auxiliary unit includes a floor; and a bottom opening formed in the floor to allow or enable passage of one or more devices.

By virtue of certain embodiments of the present disclosure, a device can be inserted into or removed from the auxiliary unit using the bridge crane, without necessarily going through the vertical structure, but directly from outside the structure, thus simplifying first installation, maintenance and assembly.

In one embodiment, the frame includes at least one top beam and at least one bottom beam parallel to each other.

In one embodiment, the bridge crane includes a guide forming an integral part of the frame.

In one embodiment, the guide extends over a floor, and is longer than the floor so as to extend partly inside the nacelle.

By virtue of certain embodiments of the present disclosure, the auxiliary unit can be fitted to the nacelle to locate the auxiliary chamber adjacent to the nacelle and so locate at least one device adjacent to the rotary electric machine. Moreover, the auxiliary unit may be assembled before or after the device is assembled inside it.

In one embodiment, the auxiliary chamber has a rear seat and lateral seats for housing a number or quantity of devices.

By virtue of certain embodiments of the present disclosure, once the auxiliary unit is fitted to the nacelle, the number or quantity of devices are located adjacent to the rotary electric machine, so energy is conducted more efficiently from the rotary electric machine to the number or quantity of devices.

Another object of the present disclosure is to provide a wind power turbine configured to eliminate certain of the drawbacks of certain known wind power turbines.

According to one embodiment of the present disclosure, there is provided a wind power turbine including a vertical structure; a nacelle fitted in rotary manner to the vertical structure; a rotary electric machine; and an auxiliary unit including a frame connected removably to the nacelle of the wind power turbine; an auxiliary chamber for housing at least one device; and a bridge crane configured to handle the at least one device inside and outside the auxiliary chamber.

By virtue of certain embodiments of the present disclosure, the wind power turbine has an auxiliary chamber for locating the at least one device adjacent to the rotary electric machine to enhance the efficiency of the turbine. The present disclosure also provides for retrofit enhancing existing wind power turbines.

Also, the device can be inserted into or removed from the auxiliary chamber using the bridge crane, without necessarily going through the vertical structure, but directly from outside the structure, thus simplifying first installation, maintenance and assembly.

In one embodiment, the nacelle has at least one opening for housing part of the auxiliary unit in the nacelle.

By virtue of certain embodiments of the present disclosure, the auxiliary unit is connected removably to the nacelle, to enhance the flexibility of the wind power turbine. In such embodiments, at first installation, the device may be fitted to the auxiliary unit on the ground, and the auxiliary unit then fitted to the nacelle; or the auxiliary unit may be fitted to the nacelle, and the device then fitted to the auxiliary unit using the bridge crane. The wind power turbine is also more flexible in terms of maintenance, thus reducing downtime and maintenance costs.

In one embodiment, the bridge crane includes a guide defining part of the frame and extending partly inside the nacelle.

By virtue of certain embodiments of the present disclosure, the bridge crane can move, and so manoeuvre the device or other units, inside the nacelle, thus improving manoeuvrability and simplifying first installation and maintenance.

In one embodiment of the present disclosure, the guide extends over the vertical structure to enable the bridge crane to perform loading and unloading operations inside the vertical structure.

By virtue of certain embodiments of the present disclosure, the bridge crane can move one or more devices from the vertical structure to the auxiliary unit, and vice versa, through the nacelle, thus greatly improving maneuverability of the devices at both assembly and maintenance stages, and so simplifying assembly and handling work as a whole.

Another object of the present disclosure is to provide a wind power turbine assembly method configured to eliminate certain of the drawbacks of certain known wind power turbine assembly methods.

According to one embodiment of the present disclosure, there is provided a wind power turbine assembly method, the wind power turbine including a vertical structure; a nacelle; and an auxiliary unit including a frame configured to assemble to the nacelle; the method including the steps of assembling a rotary electric machine to the nacelle; assembling a device to the frame; and assembling the frame of the auxiliary unit to the nacelle.

The present disclosure provides for simplifying assembly of a wind power turbine by making it more modular in design or configuration, and for reducing construction cost by virtue of the economy of scale this affords. The present disclosure also has the advantage of enabling all the connections and testing to be carried out on the ground, (i.e., faster, easier, with more work space, and in safer working conditions), as opposed to many meters off the ground.

Additional features and advantages are described in, and will be apparent from, the following Detailed Description and the figures.

### BRIEF DESCRIPTION OF THE DRAWINGS

A number of non-limiting embodiments of the present disclosure will be described by way of example with reference to the accompanying drawings, in which:

FIG. 1 shows a partly hatched side view, with parts removed for clarity, of a wind power turbine and auxiliary unit in accordance with the present disclosure;

FIG. 2 shows a view in perspective of a detail in FIG. 1;

FIG. 3 shows a top plan view of a detail in FIG. 1; and

FIG. 4 shows a view in perspective of an alternative embodiment to FIG. 1.

### DETAILED DESCRIPTION

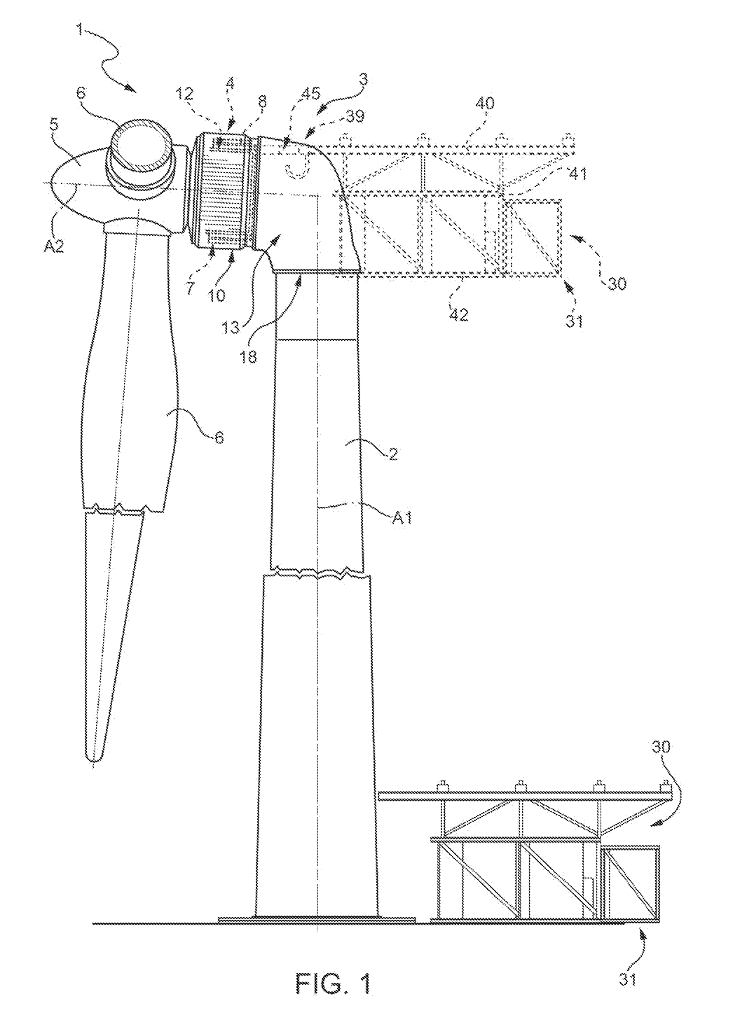

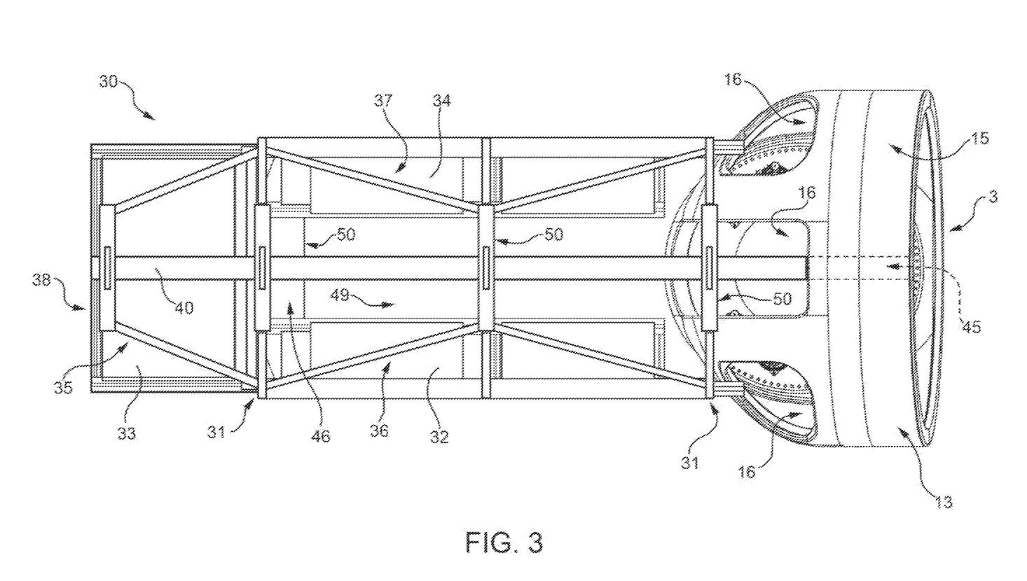

Referring now to the example embodiments of the present disclosure illustrated in FIGS. 1 to 4, number 1 in FIG. 1 indicates as a whole a wind power turbine for producing electric energy, and which includes a vertical structure 2; a nacelle 3; a rotary electric machine 4; a hub 5; and three blades 6 (only two shown in FIG. 1). Nacelle 3 is mounted to rotate with respect to vertical structure 2 about an axis A1, and hub 5 rotates with respect to nacelle 3 about an axis A2. Rotary electric machine 4 includes a stator 7 partly defining nacelle 3, or rather the outer shell of nacelle 3; and a rotor 8 connected rigidly to hub 5. A bearing is located between stator 7 and rotor 8, close to the connection of hub 5 to rotor 8.

Stator 7 includes a tubular body 10, and a number or quantity of active stator sectors arranged about axis A2 and fitted to tubular body 10; and rotor 8 includes a tubular body 12, and a number or quantity of active rotor sectors arranged about axis A2 and fitted to tubular body 12.

The active stator and rotor sectors extend parallel to axis A2, are positioned facing one another and separated by a gap, and are insertable and removable axially with respect to respective tubular bodies 10 and 12. In the example shown, rotary electric machine 4 is a synchronous, permanent-magnet electric machine; each active stator sector is defined by a magnetic guide coupled to a coil (not shown); and each active rotor sector is defined by magnetic guides coupled to permanent magnets.

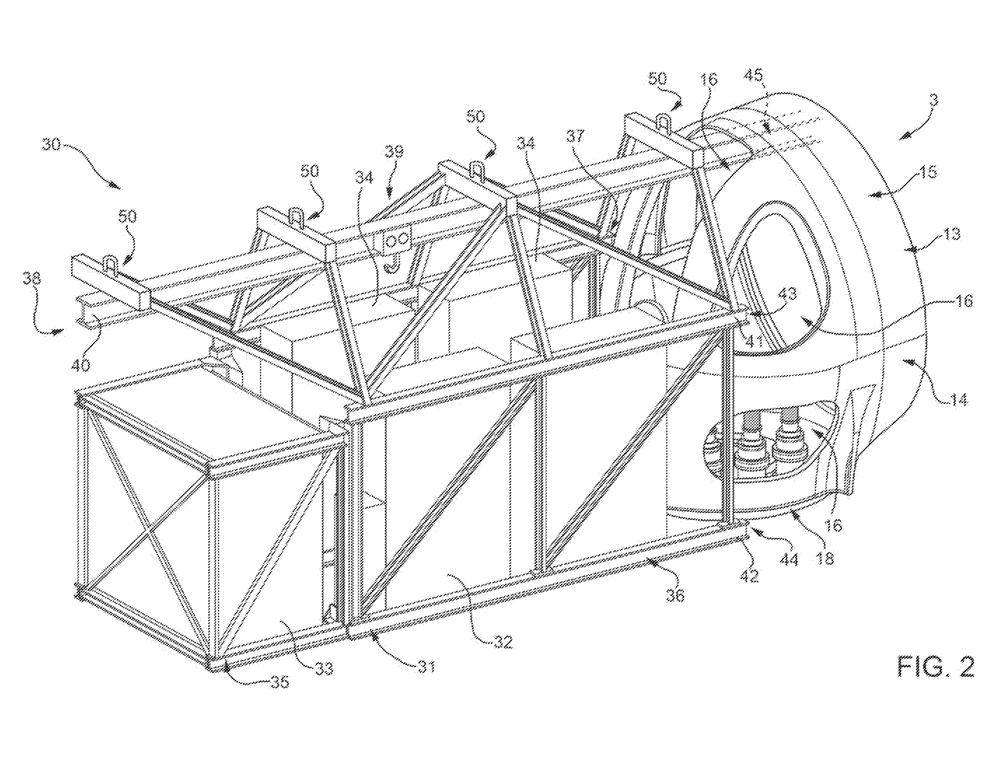

As shown in FIG. 2, nacelle 3 includes an outer shell 13, in turn including a bottom nacelle portion 14 and a top nacelle portion 15, in both of which are formed openings 16. Nacelle portions 14 and 15 may be transported separately and assembled at the installation site of wind power turbine 1.

Nacelle 3 includes a flange 18 for connection to a pivot of vertical structure 2.

More specifically, bottom portion 14 of nacelle 3 includes flange 18 for connection to the pivot, and top portion 15 is connected to bottom portion 14.

With reference to the attached drawings, wind power turbine 1 includes an auxiliary unit 30 with a frame 31 for connection to nacelle 3 of wind power turbine 1; and three devices 32, 33, 34 configured to condition the electric energy produced by rotary electric machine 4, for supply to the electric power grid.

Auxiliary unit 30 includes an auxiliary chamber formed in frame 31 to house devices 32, 33, 34, and including a rear seat 35 and two lateral seats 36, 37.

Electric energy conditioning device 33 is an electric transformer housed in rear seat 35 in the auxiliary chamber.

Devices 32 and 34 are switch converters housed in respective lateral seats 36 and 37, and configured to convert electric quantities, such as voltage and/or frequency and/or current, of the electric energy from rotary electric machine for supply to the power grid.

Auxiliary unit 30 includes a bridge crane 39 for handling devices 32, 33, 34. Frame 31 includes a top central beam 40 fitted in part inside nacelle 3, and which defines a guide 38 of the bridge crane 39. The guide 38 extends along auxiliary unit 30 and inside nacelle 3 so as to allow the bridge crane 38 to handle devices 32, 33, 34 inside the auxiliary chamber and nacelle 3. In other words, bridge crane 39 is connected movably to top central beam 40.

Frame 31 includes top beams 41 and bottom beams 42 parallel to one another and having respective ends 43 and 44; top beams 41 are fixed inside nacelle 3 through openings 16; and bottom beams 42 are fixed outside nacelle 3.

Nacelle 3 has an opening 45 formed in top portion 15 of nacelle 3, and which extends parallel to axis A2 along the whole length of nacelle 3 to house top central beam 40.

In other words, top central beam 40 is inserted inside opening 45 over the whole length of nacelle 3, so auxiliary unit 30 extends mostly outside nacelle 3.

Bridge crane 39, connected to top central beam 40, is configured to move from a first position, in which bridge crane 39 is located inside nacelle 3 and adjacent to rotary electric machine 4, to a second position, in which bridge crane 39 is located at one end of top central beam 40, outside nacelle 3 and over rear seat 35. Auxiliary unit 30 also includes a floor 46 located on the bottom side of auxiliary unit 30 and connected to frame 31 to allow or enable passage of maintenance workers.

Auxiliary unit 30 has a bottom opening 49 formed in floor 46 and closed by a removable hatch to allow or enable insertion and removal of devices 32, 33, 34 in and out of auxiliary unit 30 using bridge crane 39.

Devices 32, 33, 34 can also be inserted and removed, using bridge crane 39, through the passage in nacelle 3 and vertical structure 2.

Auxiliary unit 30 also includes external reversible connecting devices 50 connected to top central beam 40 to handle auxiliary unit 30 using cranes or similar devices.

Auxiliary unit 30 also includes an outer casing (not shown) enclosing the auxiliary chamber and frame 31 to protect devices 32, 33, 34 and other equipment inside the auxiliary chamber from external agents.

When constructing auxiliary unit 30, devices 32, 33, 34 are fitted to frame 31 before fixing auxiliary unit 30 to nacelle 3 using a crane. This has the advantage of enabling all the connections and testing to be carried out on the ground, as opposed to many meters off the ground, which enables or allows workers more space in which to move freely, and so simplifies maintenance, and reduces maintenance time, downtime, and cost.

According to another operational mode adopted during the servicing, devices 32, 33, 34 are fitted to the frame 31 after frame 31 is fitted to nacelle 3. More specifically, devices 32, 33, 34 are attached to bridge crane 39 and hoisted through bottom opening 49 into frame 31. This simplifies maintenance and replacement of devices 32, 33, 34.

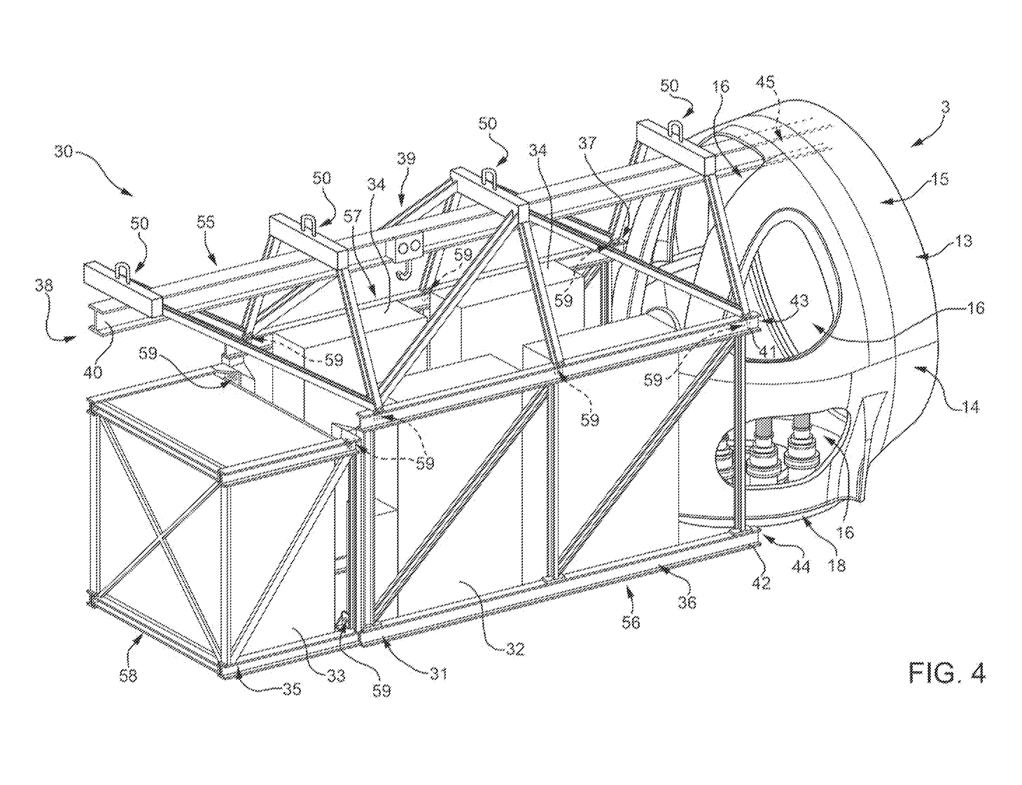

In one embodiment shown in FIG. 4, frame 31 is divided into a top frame portion 55; two lateral frame portions 56, 57, one for each side; and a rear frame portion 58. Top frame portion 55 is connected to the two lateral frame portions 56, 57 by fasteners 59; rear frame portion 58 is connected to lateral frame portions 56, 57 by fasteners 59; top frame portion 55 includes bridge crane 39, guide 38, and top central beam 41; rear frame portion 58 defines rear seat 35; and lateral frame portions 56 and 57 comprise top beams 41 and bottom beams 42, and define respective lateral seats 36 and 37.

Frame portions 55, 56, 57, 58 are transported separately and later assembled into frame 31 at the installation site.

By virtue of certain embodiments of the present disclosure, auxiliary unit 30 can be fitted to the outside of nacelle 3, adjacent to rotary electric machine 4, thus solving the problems posed by limited manoeuvring space inside wind power turbine 1, and with no need for long electric cables. More specifically, auxiliary unit 30 can be moved into position and fixed to nacelle 3 using an external crane, and may also be used to advantage for retrofit enhancing existing wind power turbines.

Clearly, changes may be made to the equipment and method as described herein without, however, departing from the scope of the accompanying Claims. That is, the present disclosure also covers embodiments not described herein and equivalent embodiments, which nevertheless fall within the protective scope of the accompanying Claims. It should thus be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A wind power turbine auxiliary unit comprising:
a frame configured to connect to a wind power turbine nacelle of a wind power turbine, said frame defining an auxiliary chamber configured to house at least one device configured to condition electric energy produced by a rotary electric machine of the wind power turbine; and
a bridge crane configured to handle the at least one device inside of the defined auxiliary chamber and outside of the defined auxiliary chamber.

2. The wind power turbine auxiliary unit of claim 1, which includes a floor defining a bottom opening to enable passage of the at least one device.

3. The wind power turbine auxiliary unit of claim 1, wherein the frame includes at least one top beam and at least one bottom beam parallel to each other.

4. The wind power turbine auxiliary unit of claim 1, wherein the bridge crane includes a guide.

5. The wind power turbine auxiliary unit of claim 4, wherein the guide extends over a floor and is longer than the floor to extend partly inside the wind power turbine nacelle.

6. The wind power turbine auxiliary unit of claim 1, wherein the auxiliary chamber has a rear seat and at least one lateral seat configured to house a plurality of devices.

7. The wind power turbine auxiliary unit of claim 1, wherein the frame is divided into a plurality of frame portions connected to one another and defining the auxiliary chamber.

8. A wind power turbine comprising:
a vertical structure;
a nacelle rotatably fitted to the vertical structure;
a rotary electric machine; and
an auxiliary unit including:
a frame removably connected to the nacelle,
an auxiliary chamber configured to house at least one device, and
a bridge crane configured to handle the at least one device inside of the auxiliary chamber and outside of the auxiliary chamber.

9. The wind power turbine of claim 8, wherein the nacelle has at least one opening configured to house part of the auxiliary unit.

10. The wind power turbine of claim 8, wherein the bridge crane includes a guide defining part of the frame and extending partly inside the nacelle.

11. The wind power turbine of claim 10, wherein said guide extends over the vertical structure to enable the bridge crane to perform loading and unloading operations inside at least one of the vertical structure and the nacelle.

12. The wind power turbine of claim 8, wherein the nacelle is divided into at least two nacelle portions connected to each other.

13. A method of assembling a wind power turbine comprising:
assembling a rotary electric machine to a wind power turbine nacelle;
assembling at least one device to a frame of a wind power turbine auxiliary unit; and
assembling the frame of the wind power turbine auxiliary unit to the wind power turbine nacelle.
